(19) United States
(12) Patent Application Publication
(10) Pub. No.: US 2005/0069741 A1
(43) Pub. Date: Mar. 31, 2005

(54) Fuel cell system

(76) Inventors: Yutaka Enokizu, Oyama (JP); Koichi Sakamoto, Ohira (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/901,961

(22) Filed: Jul. 30, 2004

(30) Foreign Application Priority Data
Sep. 26, 2003 (JP) 2003-334501

(51) Int. Cl. H01M 8/04; H01M 8/06

(52) U.S. Cl. 429/26; 429/19; 429/24; 429/13

(57) ABSTRACT

A stack that is supplied with reform gas containing hydrogen that is produced by a reformer by reforming source fuel to serve as anode gas and air containing oxygen to serve as cathode gas, and it performs power generation. The stack has a circulation channel for stack cooling water through which the stack cooling water flows for maintaining he temperature of the stack. There is a first heat exchanger that performs heat exchange between anode exhaust gas and exhaust gas recovery water; a second heat exchanger that performs heat exchange between cathode exhaust gas and the exhaust gas recovery water; a third heat exchanger that performs heat exchange between the stack cooling water and the exhaust gas recovery water; and a fourth heat exchanger that performs heat exchange between the reform gas and the exhaust gas recovery water. These heat exchangers are disposed in series in a channel of the exhaust heat recovery water.

### BACKGROUND OF THE INVENTION

The present invention relates to a fuel cell system.

The fuel cell system reforms source fuel, such as city gas and propane gas, in a reformer; supplies a hydrogen rich gas obtained from the reformer to a fuel cell stack; and makes the hydrogen rich gas react with oxygen in air, thereby performing power generation. A fuel cell cogeneration system recovers heat generated in the course of power generation and stores it as hot water, and the hot water is supplied to a hot-water supply or is used for heating the home.

An example of a conventional layout of an exhaust heat recovery system and the heat exchangers used therein is described in JP-A-2003-217620. FIG. 4 shows a block diagram of such a layout.

In the system of FIG. 4, a heat exchanger 6 is provided to exchange heat between exhaust gas from the anode (anode exhaust gas) and exhaust heat recovery water, and a heat exchanger 15 is provided to exchange heat between exhaust gas from the cathode (cathode exhaust gas) and cooling water for a fuel cell stack. In addition, a heat exchanger 7 is provided to exchange heat between the cathode exhaust gas and the exhaust heat recovery water downstream of the heat exchanger 15. The heat quantity generated with the power generation is exchanged with the heating of the exhaust heat recovery water by the heat exchangers 6 and 7, and it is stored in a shown hot-water tank (not shown) as hot water.

The heat exchanger 15 performs heat exchange between the cathode exhaust gas and the stack cooling water. The purpose of this is to control the temperature of the cooling water stored in a stack cooling water tank 3 optimally (for example, to maintain it at 50° C. to 70° C.), stabilize the temperature of the fuel cell stack, and stabilize the power generation operation of the system. The stack cooling water and exhaust heat recovery water, which serve as liquid media flowing through the heat exchangers, are subjected to flow rate control in stack cooling water pumps 4, 16 and an exhaust heat recovery water pump (not shown) which supplies exhaust heat recovery water to the heat exchanger 7, respectively. A temperature detector 12, such as a thermocouple or thermistor, is installed for the fuel cell stack. The flow rate through the stack cooling water pump 4 is controlled depending on the value indicated by the temperature detector 12 in order to maintain the fuel cell stack at a constant temperature (for example, 65° C. to 75° C.) during the power generation.

A temperature detector 16′, such as thermocouple or thermistor, is installed for the cooling water in the stack cooling water tank 3. The flow rate through the stack cooling water pump 16 is controlled depending on the detection results of the temperature detector 16′ in the stack cooling water tank during the power generation.

### SUMMARY OF THE INVENTION

The following attributes are required for the above-described method of recovering exhaust heat in a fuel cell system. First, it is required to recover the heat generated in the power generation efficiently. Then, it is required that the system effecting the power generation not become unstable due to the heat recovery and that are operation be carried out stably.

Furthermore, it is required that the temperature of the hot-water in the exhaust heat recovery remain constant. Thus, as shown in FIG. 5, a temperature detector 17, such as a thermocouple or thermistor, is installed for the hot water stored in the hot-water tank, and the flow rate through the exhaust heat recovery pump 5 is controlled such that the hot-water temperature is controlled to be constant (for example, 60° C. to 75° C.).

According to the above-described conventional exhaust heat recovery system, the temperature of the fuel cell stack and the hot-water temperature in the exhaust heat recovery are made to be constant, and a stable power generation operation and exhaust heat recovery operation are possible. However, the following problems occur.

First, three water pumps are required for controlling the flow rate of the liquid media that is being circulated for cooling the stack or performing heat exchange with the stack; therefore, the configuration of the equipment is complicated, and miniaturization and cost reduction are prevented.

Second, since detection and control of the temperature for each flow control is performed independently, when the rate of flow through a pump is changed to maintain a desired condition, the temperature condition of the flow has an effect on the heat exchange condition of the heat exchanger on the downstream side, and thus control of the rate of flow through the other pump is necessary. Therefore, the control system is complicated.

As a third problem, since the fuel cell cogeneration system stores hot water in the hot-water tank and uses it as a hot-water supply for the home, a temperature of 60° C. or above is required as the temperature of the hot water that is being stored. When the temperature of the hot water is detected before it flows into the hot-water tank, and the hot-water temperature is controlled, for example, to 60° C. in order to control the flow rate of the exhaust heat recovery water, the flow rate of the exhaust heat recovery water becomes excessive, and, in some cases, the temperature condition of the medium for the heat exchange is unstable, resulting in an unstable operation.

Fourth, when the controlled temperature is raised to increase the temperature of the hot water that is stored in the hot-water tank to 65° C. or 70° C., the heat quantity can not be recovered sufficiently, and sometimes it is discharged as exhaust heat.

The invention, which was made in view of the above-described problems, has an object to provide a fuel cell system in which the energy efficiency is excellent with a simple configuration and a stable operation is possible.

Still further advantages of the present invention will become apparent to those of ordinarily skill in the art upon reading and understanding the following detailed description of the preferred and alternate embodiments.

### BRIEF DESCRIPTION OF THE DRAWINGS

The invention will be described in conjunction with the appended drawings, which are provided only for the purpose of illustration of the preferred and alternate embodiments of the invention, and not for the purpose of limiting the same, wherein:

FIG. 1 is a general block diagram of a fuel cell cogeneration system according to a first embodiment of the present invention;

FIG. 2 is a general block diagram of a fuel cell cogeneration system according to a second embodiment of the present invention;

FIG. 3 is a general block diagram of a fuel cell cogeneration system according to a third embodiment of the present invention;

FIG. 4 is a block diagram showing an example of a conventional fuel cell cogeneration system; and

FIG. 5 is a block diagram showing an example of a fuel cell cogeneration system.

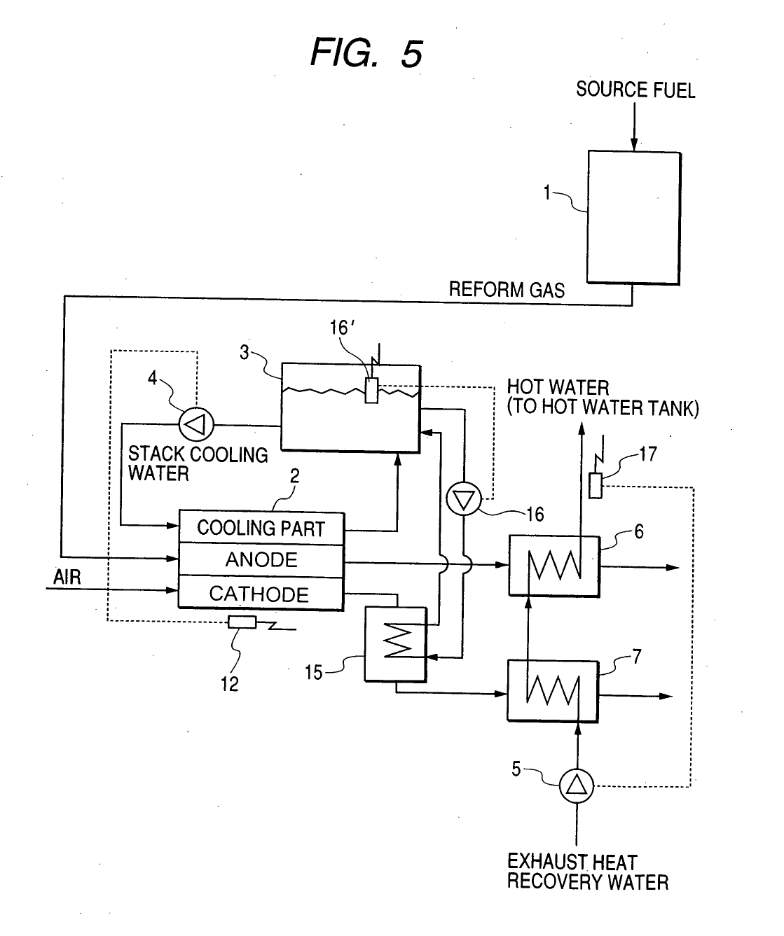

### DESCRIPTION OF THE PREFERRED EMBODIMENTS

Embodiments of a fuel cell system according to the present invention will be described with reference to the accompanying drawings.

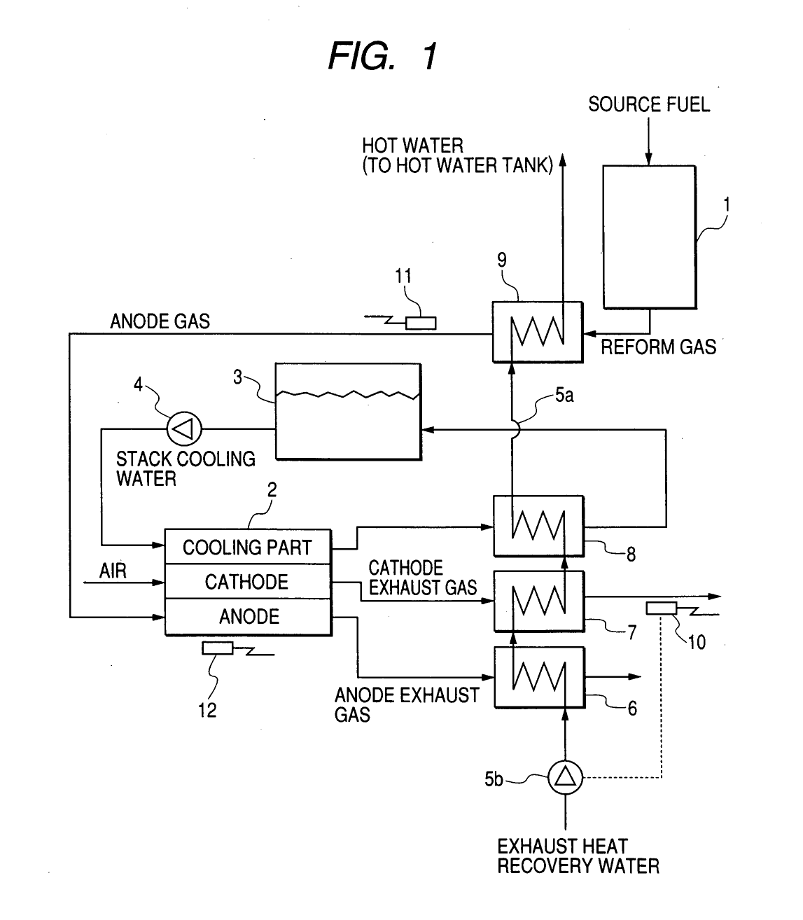

FIG. 1 shows an example of a fuel cell cogeneration system according to the present invention. A reformer 1 is supplied with city gas or propane gas, which serves as a source fuel. Hydrogen rich gas which serves as a reform gas is obtained from the source fuel. The hydrogen rich gas is supplied to the anode of a fuel cell stack 2 as anode gas. On the other hand, air is supplied to the cathode of the fuel cell stack 2 as cathode gas by a blower (not shown). To cool the fuel cell stack 2, a cooling tank 3 and a cooling pump 4 are provided. The stack cooling water is supplied to a cooling part of the fuel cell stack 2, and it circulates between the cooling tank 3 and the cooling part of the fuel cell stack 2.

From the anode and cathode of the fuel cell stack 2, the anode exhaust gas and the cathode exhaust gas, respectively, are discharged as exhaust gas after power generation. In some cases, the anode gas or cathode gas supplied to the fuel cell stack 2 is passed through a bubbler unit (not shown) to moisten an electrolyte film disposed within the fuel cell stack 2. In this embodiment, water for heat exchange circulates for the purpose of recovering the heat generated with the power generation of the fuel cell. Exhaust heat recovery water (typically running water), which serves as the water for heat exchange, circulates in a circuit 5a through which the exhaust heat recovery water flows. An exhaust heat recovery pump 5b is disposed at an upstream side of the circuit 5a, and a hot-water tank (not shown) is disposed at the most downstream side, whereby excessive heat is recovered.

In this embodiment, heat exchangers for effecting the exhaust heat recovery are disposed in the following manner. First, a first heat exchanger 6 that performs heat exchange between the anode exhaust gas and the exhaust heat recovery water is disposed at an upstream side of the circulation channel 5a of the exhaust heat recovery water. Next, a second heat exchanger 7, that performs heat exchange between the cathode exhaust gas and the exhaust heat recovery water, is disposed in series with the heat exchanger 6. Next, a third heat exchanger 8, that performs heat exchange between the cooling water for the fuel cell stack and the exhaust heat recovery water, is disposed in series with the heat exchanger 8. Next, a fourth heat exchanger 9, that performs heat exchange between the reform gas and the exhaust heat recovery water, is disposed in series with the heat exchanger 8.

The exhaust heat recovery water sequentially recovers heat in this order, and it is stored in the hot-water tank disposed at the most downstream side as hot water to be used for the hot-water supply for the home.

Here, it is for the following reason that the heat exchangers 6 and 7 are disposed in the above-described order. That is, the cathode exhaust gas contains reaction water generated in the stack during the time the water passes through the stack, and it contains a large quantity of condensation heat. Therefore, if the heat exchanger 7 that performs heat exchange between the cathode exhaust gas and the exhaust heat recovery water is disposed at an upstream side of the heat exchanger 6, the heat exchanger 6 disposed at the downstream side thereof can not perform the required heat exchange sufficiently.

A heat exchanger that performs heat exchange between exhaust gas discharged from a shown combustion part (not shown) of the reformer 1 and the exhaust heat recovery water may be added. The added heat exchanger is desirably connected in series with the heat exchangers 6, 7, 8, and 9, and it is to be disposed at a further downstream side of the heat exchangers 6, 7, 8, and 9. Although combustion exhaust gas is discharged from the reformer 1, the exhaust gas can be subjected to heat recovery even at the downstream side because it is hot.

The exhaust heat recovery water pump 5b that circulates the exhaust heat recovery water is a flow regulation type of pump, and it is controlled by a shown flow regulation controller (not shown). Here, when the flow rate is changed by using a combination of a constant speed pump and a flow control valve, similar effects are obtained. By changing the flow rate using the exhaust heat recovery water pump 5b, heat from a heating medium that is usable for the heat exchange can be recovered efficiently without wasting the heat. In addition, an operation depending on the load of the power generation or calorific value of a fuel cell can be performed stably without absorbing excessive heat.

By arranging the heat exchangers in the manner shown in FIG. 1, if the speed of the stack cooling water pump 4, which generally requires variable flow control, is made constant, stable heat recovery also can be performed. The reason for this is as follows.

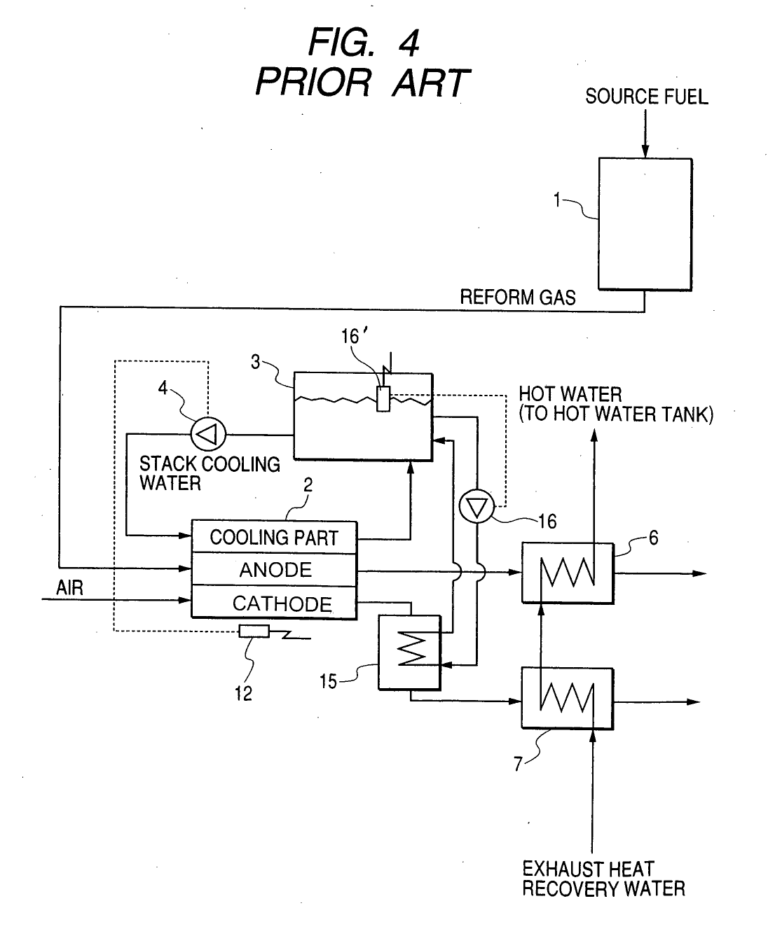

Since the fuel cell stack 2 generates heat during power generation, the stack cooling water is intended to remove the heat and to keep the temperature of the fuel cell stack 2 optimum for operation. In the configuration of the system described with reference to FIG. 4, the circulation rate of the cooling water is changed with changes in the stack temperature being monitored. That is, when the stack temperature increases, the flow rate of the cooling water is increased, and when the stack temperature decreases, the flow rate of the cooling water is decreased.

In contrast, the method of the present invention performs heat exchange between the stack cooling water and the exhaust heat recovery water using the heat exchanger 8. In this method, the circulation flow rate of the stack cooling water is not controlled, so that the temperature of the stack cooling water can be controlled optimally by the exhaust heat recovery water and heat exchange. That is, the present invention employs a method of “constant flow rate and variable temperature”, rather than a method of “variable flow rate and constant temperature” as used in the conventional control of the stack cooling water. Since the flow rate of the exhaust heat recovery water is controlled depending on the temperature of the cathode exhaust gas, the temperature of the stack cooling water varies depending on the flow rate. Accordingly, the stack temperature is controlled spontaneously by a heat balance. Hereinafter, a detailed explanation of this will be given.

The heat exchanger 8 that performs the heat exchange between the stack cooling water and the exhaust heat recovery water is provided downstream of the heat exchangers 6 and 7 for the anode exhaust gas and the cathode exhaust gas, respectively, and the stack cooling water is subjected to heat exchange with the exhaust heat recovery water after the heat exchange with the anode exhaust gas and the cathode exhaust gas has been effected.

As described above, the temperature of the fuel cell stack 2 is kept approximately constant during operation. At that time, the temperature of the anode exhaust gas and the temperature of the cathode exhaust gas do not increase to the temperature of the fuel cell stack 2 or above. Therefore, the exhaust heat recovery water at an upstream side of the heat exchanger 8 for heat exchange with the stack cooling water does notsearch the temperature of the fuel cell stack 2 or above even if the flow rate is low.

The fuel cell stack 2, since it generates heat during power generation, is maintained at a temperature appropriate for the power generation of the stack 2 by the stack cooling water. When the temperature of the stack cooling water increases, the stack cooling water supplies heat corresponding to the increased temperature to the exhaust heat recovery water in the heat exchanger 8, and then it flows back to the stack cooling water tank 3.

Accordingly, when the temperature of the fuel cell stack 2 increases, the temperature of the exhaust gas increases. At that time, control is carried out such that the flow rate of the exhaust heat recovery water increases, as described above. When the flow rate of the exhaust heat recovery water increases, in addition to the effect of the heat recovery from the exhaust gas, the cooling effect of the stack cooling water increases.

Accordingly, stable heat recovery can be performed by making the speed of the stack cooling water pump 4 constant, the pump 4 generally requiring variable flow rate control. By making the stack cooling water pump 4 operate as a constant speed pump, cost reduction in the pump is achieved, or the need for equipment, such as the flow control valve, becomes unnecessary, leading to a cost reduction in the system and simplicity of the control system.

A temperature detector 10, such as a thermocouple or thermistor, for detecting the temperature of the cathode exhaust gas is provided at the outlet of the heat exchanger 6, which effects heat exchange between the cathode exhaust gas and the exhaust heat recovery water. The control section that changes the flow rate of the exhaust heat recovery water pump 5b performs its operation efficiently by controlling the flow rate of the exhaust heat recovery water depending on the temperature detected by the temperature detector 10. Since the cathode exhaust gas is supplied to the heat exchanger 7 in a condition of having a large quantity of condensation heat due to moistened air and water generated with the power generation of the fuel cell, it is most responsible for the exhaust heat recovery. Therefore, the flow rate of the exhaust heat recovery water is controlled optimally depending on the temperature condition of the cathode exhaust gas, whereby heat exchange at the later stream side is also performed optimally.

The heat exchanger 9, which effects heat exchange between the reform gas and the exhaust heat recovery water, is disposed at the end of the circulation channel 5a, whereby the temperature of the anode gas at the inlet of the fuel cell stack can be automatically controlled to be slightly low compared with the temperature of the fuel cell stack. Moreover, the anode gas is prevented from flowing into the fuel cell stack in a hot saturated-steam state, and thus blockage of the gas channel due to water condensation in the fuel cell stack can be eliminated. Accordingly, stabilization in the power generation operation and improvement of the reliability can be achieved.

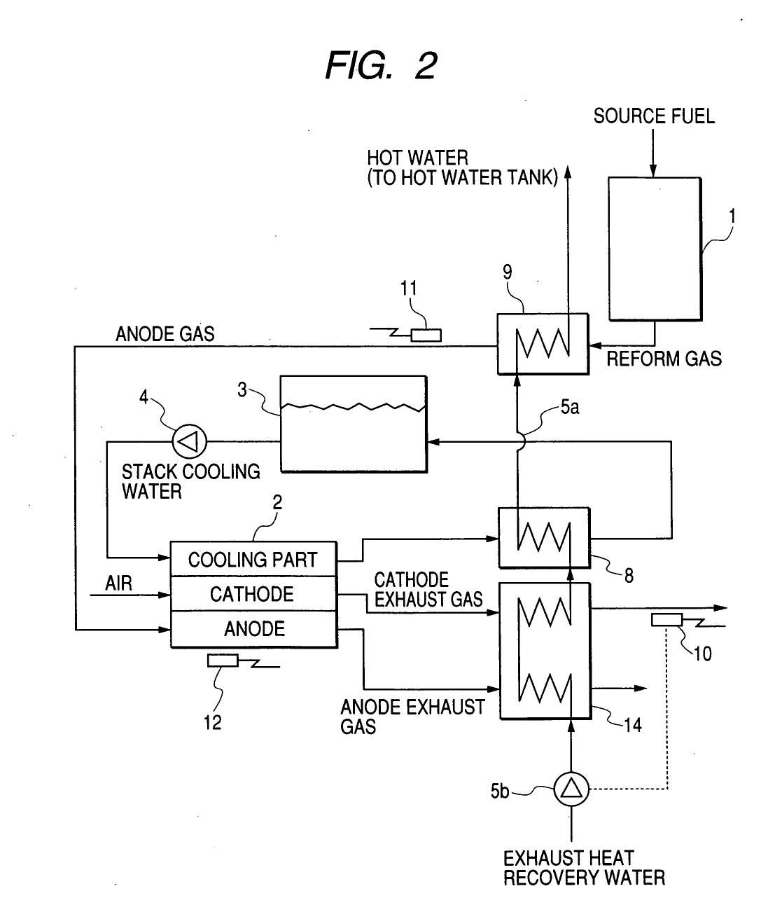

For the heat exchangers in such a layout, a binary-fluid heat exchanger is not necessarily used in all cases. For example, similar effects are obtained by installing a ternary-fluid heat exchanger for effecting heat exchanger between the anode exhaust gas and the cathode exhaust gas, and the exhaust gas recovery water, as shown in FIG. 2. According to this configuration, a reduction of the installation space and a reduction of the heat radiation from piping among the heat exchangers are possible. Also, in the case where a quadruple-fluid heat exchanger, to which the stack cooling water is further added, is installed, similar effects are obtained, and a further reduction of the installation space and a reduction of the heat radiation from piping among the heat exchangers are possible.

Next, a case will be described, wherein the temperature of the anode gas becomes unstable when the phase of the reformer 1 transiently varies, for example, at operation start-up, at an initial stage of power generation, and at a load change point.

The system shown in FIG. 1 has a heat exchanger 9 that performs heat exchange between the reform gas produced by the reformer 1 and the exhaust heat recovery water. In addition, the system has a temperature detector 11, such as a thermocouple or a thermistor, for detecting the temperature of the anode gas after it passes through the heat exchanger 9. The flow rate of the exhaust heat recovery water is controlled depending on the temperature of the anode gas detected by the temperature detector 11. When anode gas containing hot saturated steam is supplied to the fuel cell stack, a blockage of the gas channel occurs due to the water condensation in the fuel cell stack 2. At that time, the fuel cell stack is partially in a fuel shortage condition; therefore, the power generation becomes unstable, and, in addition, breakdown of the cell itself may occur.

Therefore, the temperature of the cathode exhaust gas after heat exchange is detected by the temperature detector 10, such as a thermocouple or a thermistor, and an operation is carried out such that the temperature (saturated steam amount) of the anode gas supplied to the fuel cell stack is optimally controlled. Specifically, in the case where the operation condition is unstable, for example, the operation start-up or switching of an operation condition at the time of power generation, the temperature of the anode gas is detected by the anode gas temperature detector 11, and the temperature of the fuel cell stack 2 is detected by a temperature detector 12. When the temperature of the anode gas is high compared with the temperature of the fuel cell stack 2, control is carried out so that the flow rate of the exhaust heat recovery water is increased, thereby the water condensation in the fuel cell stack 2 is restrained and the power generation operation is stabilized. By adding the detection and control of the temperature, a more stable operation is possible.

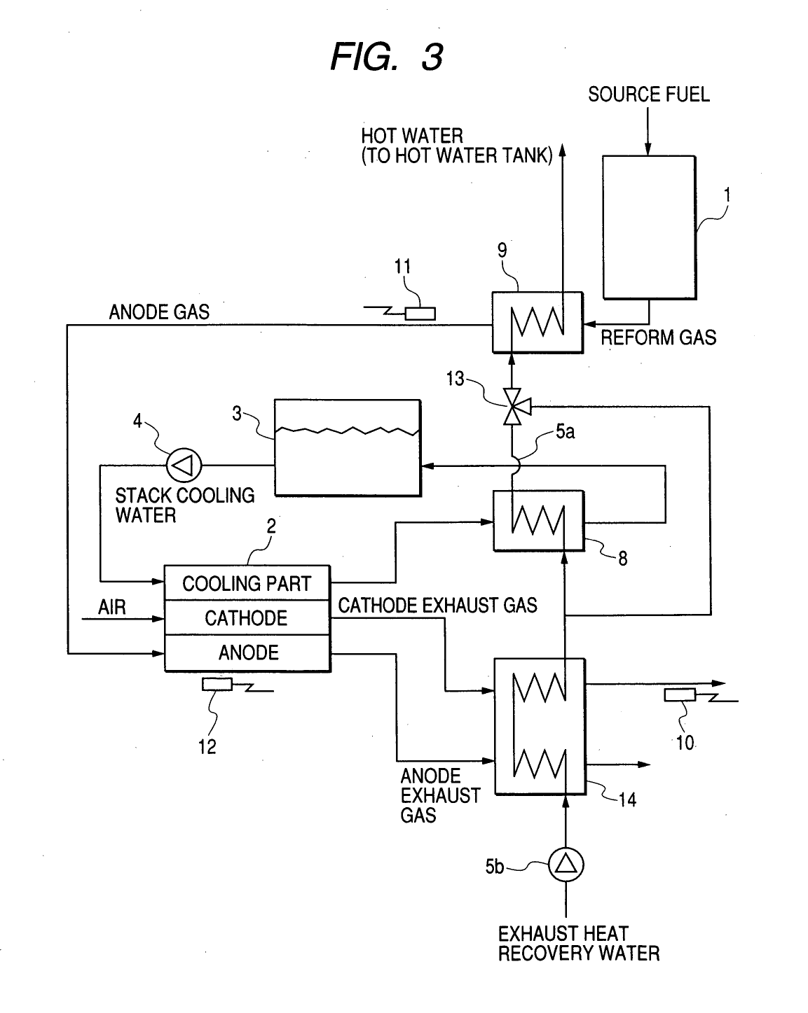

At this time, a case will be described wherein an unstable condition occurs during system operation. FIG. 3 shows a general block diagram of the embodiment. In the example shown in FIG. 3, similar to the example shown in FIG. 2, the heat exchanger system for exhaust heat recovery has a ternary-fluid heat exchanger 14 that performs heat exchange between the anode exhaust gas or cathode exhaust gas and the exhaust heat recovery water, a heat exchanger 8 that performs heat exchange between the stack cooling water and the exhaust heat recovery water, and a heat exchanger 9 that performs heat exchange between the reform gas and the exhaust heat recovery water. In this configuration, a bypass system for bypassing the heat exchanger 8 is provided, so that the heat exchanger 8 is capable of performing heat exchange between the stack cooling water and the exhaust heat recovery water, switching of the system to bypass the heat exchanger 8 can be carried using a three-way valve 13.

When the power generation operation is performed at low load in the fuel cell cogeneration system, heat generation from the fuel cell stack is reduced. Therefore, when the exhaust heat recovery water recovers heat from the stack cooling water, the temperature of the fuel cell stack 2 is decreased by the heat recovery, and sometimes operation of the system becomes unstable. At that time, control is performed such that the three-way valve 13 is switched depending on the temperature condition indicated by the temperature detector 12 that detects the temperature of the fuel cell stack 2. The control is carried out in this manner so that the exhaust heat recovery water bypasses the heat exchanger 8 and flows through the bypass system, so that it does not recover heat from the stack cooling water. Thus, the temperature of the stack can be maintained at the optimum operating temperature, and the system operation can be stabilized.

Regarding the temperature of the anode exhaust gas and the cathode exhaust gas, although the temperature of the exhaust gas brings in a change in efficiency, it does not have an effect on the operation of the fuel cell stack 2. However, the temperature of the stack cooling water after heat exchange affects the operating temperature of the fuel cell stack 2. In the normal condition, as described above, since the exhaust heat recovery water after being subjected to heat exchange with the cathode exhaust gas has a slightly lower temperature than the temperature of the fuel cell stack 2, the heat of the stack cooling water is not absorbed uselessly. Also, when the load is low, the temperature detector 12 for detecting the temperature of the fuel cell stack 2 is provided, and the three-way valve 13 is provided such that the heat exchanger 8 that performs heat exchange between the stack cooling water and the exhaust heat recovery water can be bypassed, thereby excessive heat-absorption of the stack cooling water is prevented and operation of the system can be performed stably.

Similar effects can be obtained even in a configuration where the three-way valve is provided in a circuit at a side of the stack cooling water rather than in the circuit 5a for the exhaust heat recovery water, so that the stack cooling water bypasses the heat exchanger 8. However, for the following reasons, the system configuration of this example is desirable. First, when the configuration in which the stack cooling water bypasses the heat exchanger 8 is used, pressure loss in the stack cooling water system is changed, thereby effects on the flow rate may occur. Second, when a three-way valve of a type such that the water is turned off or a three-way valve that is totally enclosed once in switching is provided, the fuel cell stack 2 may be excessively pressurized. Accordingly, the configuration where the three-way valve 13 is provided in the exhaust heat recovery water system for the bypass is desirable.

When a quadruple-fluid heat exchanger is used, the bypass channel is desirably provided in light of the above-described situation.

According to the present invention, in the operation for effecting power generation at low load in which the heat generation is small, a bypass circuit in which the three-way valve 13 is provided for the heat exchanger 8 between the stack cooling water and the exhaust heat recovery water is installed, and the heat exchanger circuit is switched depending on the temperature condition or load condition of the power generation of the fuel cell stack 2, thereby the temperature required for the operation of the fuel cell stack 2 is maintained and a stable operation can be performed.

According to the embodiments of the invention described herein, the heat exchangers in the exhaust heat recovery system are connected in series, and the heat exchange operations between respective heat media and the exhaust heat recovery water is carried out sequentially, thereby the fuel cell system can be stably and efficiently operated in a simply controllable manner. Furthermore, a fuel cell system can be provided, where miniaturization and cost reduction are possible, complication of the control system is prevented the energy efficiency is excellent, and a stable operation is possible.

1. A fuel cell system comprising:
a stack that is supplied with reform gas containing hydrogen supplied from a reformer that produces the hydrogen by reforming source fuel as anode gas and air as cathode gas, and performs power generation;
a first heat exchanger that performs heat exchange between anode exhaust gas discharged from the stack and exhaust heat recovery water;
a second heat exchanger that performs heat exchange between cathode exhaust gas discharged from the stack and the exhaust heat recovery water;
a third heat exchanger that performs heat exchange between stack cooling water for keeping temperature of the stack and the exhaust heat recovery water,
and a fourth heat exchanger that performs heat exchange between the reform gas and the exhaust heat recovery water,
wherein said first, second, third, and fourth heat exchangers are disposed in series on a channel of the exhaust heat recovery water.

2. The fuel cell system according to claim 1,
wherein the heat exchanger that performs heat exchange between the anode exhaust gas and the exhaust heat recovery water is disposed at an upstream side of the heat exchanger that performs heat exchange between the cathode exhaust gas and the exhaust heat recovery water.

3. The fuel cell system according to claim 1,
wherein the heat exchanger that performs heat exchange between the stack cooling water and the exhaust heat recovery water is disposed at a downstream side of the heat exchanger that performs heat exchange between the anode exhaust gas and the exhaust heat recovery water and the heat exchanger that performs heat exchange between the cathode exhaust gas and the exhaust heat recovery water.

4. The fuel cell system according to claim 1,
wherein flow rate of the stack-cooling water is constant without regard to load of the power generation of the stack, and the water is circulated by a constant flow-rate pump.

5. The fuel cell system according to claim 1 having,
a pump or flow regulation valve for varying flow rate of the exhaust heat recovery water;
a cathode exhaust gas temperature detector that detects a temperature of the cathode exhaust gas after being subjected to the heat exchange by the heat exchanger that performs heat exchange between the cathode exhaust gas and the exhaust heat recovery water;
and a control section that determines the flow rate of the exhaust heat recovery water depending on the temperature of the cathode exhaust gas detected by the cathode exhaust gas temperature detector.

6. (The fuel cell system according to claim 1 having,
a pump or flow regulation valve that can vary the flow rate of the water for heat exchange;
an anode gas temperature detector that detects the temperature of the anode gas after being subjected to the heat exchange by the heat exchanger that performs heat exchange between the anode gas and the exhaust heat recovery water;
a stack temperature detector that detects a temperature of the stack;
and a control section that compares the anode gas temperature detected by the anode gas temperature detector to the stack temperature detected by the stack temperature detector, and controls the pump or flow regulation valve such that the anode gas temperature is lower than the stack temperature.

7. The fuel cell system according to claim 1 having,
a stack temperature detector that detects the temperature of the stack;
a three-way valve for bypassing the heat exchanger that performs heat exchange between the stack cooling water and the exhaust heat recovery water among the heat exchangers connected in series;
and a control section that controls the three-way valve such that the heat exchanger that performs heat exchange between the stack and the water for heat exchange is bypassed, when the stack temperature detected by the stack temperature detector decreases to a level below a normal operation temperature.

8. A waste heat recovery system for a fuel cell system that recovers heat discharged from a stack that performs power generation using gas containing hydrogen as anode gas and air as cathode gas, comprising:
a first heat exchanger that performs heat exchange between anode exhaust gas discharged from the stack and exhaust heat recovery water;
a second heat exchanger that performs heat exchange between cathode exhaust gas discharged from the stack and the exhaust heat recovery water;
a third heat exchanger that performs heat exchange between stack cooling water for keeping temperature of the stack and the exhaust heat recovery water;
and a fourth heat exchanger that performs heat exchange between the gas containing hydrogen before being supplied to the stack and the exhaust heat recovery water;
wherein said first, second, third, fourth heat exchangers are disposed in series on a channel of the exhaust heat recovery water.

9. A method of recovering heat in a fuel cell system comprising:
supplying a stack with reform gas containing hydrogen supplied from a reformer that produces the hydrogen by reforming source fuel as anode gas and air as cathode gas, and performs power generation;
a first step of exchanging heat between anode exhaust gas discharged from the stack and exhaust heat recovery water;
a second step of exchanging heat between cathode exhaust gas discharged from the stack and the exhaust heat recovery water;
a third step of exchanging heat between stack cooling water for keeping maintaining the temperature of the stack and the exhaust heat recovery water,
a fourth step of exchanging heat between the reform gas and the exhaust heat recovery water,
wherein said first, second, third, and fourth steps of exchanging heat are performed in series on a channel of the exhaust heat recovery water.
